(19) United States
(12) Patent Application Publication
(10) Pub. No.: US 2014/0028696 A1
(43) Pub. Date: Jan. 30, 2014

(54) ICC color conversion using GPU

(71) Applicant: Manish S. Kulkarni, Saratoga, CA (US)

(72) Inventor: Manish S. Kulkarni, Saratoga, CA (US)

(73) Assignee: Adobe Systems Incorporated

(21) Appl. No.: 11/189,372

(22) Filed: Jul. 26, 2005

(51) Int. Cl. G06T 19/20

(52) U.S. Cl. CPC G06T 19/20
USPC 345/582

(57) ABSTRACT

Apparatus and systems, as well as methods and articles, may operate to use a graphics processing unit (GPU) to perform color conversions using International Color Consortium (ICC) profiles. In some embodiments, code is generated for execution by the GPU. The conversion can be represented as a series of steps mapped to particular GPU processes such as 1D texture, 3D texture and matrix functions.

### TECHNICAL FIELD

Various embodiments described herein relate to color conversion generally, including apparatus, systems, and methods used to perform ICC color conversion using a graphics processing unit.

### BACKGROUND INFORMATION

Color plays an important role in conveying information. At this time, little hardware or software makes it easy, or even possible, to ensure consistent, accurate reproduction of colors across different computers and types of input/output devices.

The correct representation of a color image is a very complex and often difficult subject. Various color processing and reproduction techniques have been developed and used in several independent industries. As a result, many different color spaces have been developed to model and describe the colors of images in different applications.

In response, the International Color Consortium (“ICC”) was established with the goal of providing an open, vendor-neutral, cross-platform color management system architecture. One of the main efforts of ICC is to provide a universal approach to enable a clear definition of all the variables involved in the handling of colors by a device. This approach is based on a working concept called a “profile connection space,” wherein each device has a “color profile” that describes the color management parameters used by the device. The format of the color profiles is described in the current ICC Specification ICC.1:2004-10. Such device profiles are used to translate color data created or processed on one device into the native color space of another device. By embedding device profiles in color image data and performing color translations based on the profiles, color data can be transparently moved across devices and operating systems.

### BRIEF DESCRIPTION OF THE DRAWINGS

FIG. 1 is a block diagram illustrating a system of an embodiment of the present invention;

FIG. 2 is a block diagram illustrating a processing application of an embodiment of the present invention;

FIG. 3A is a simplified flow chart illustrating an embodiment of the present invention;

FIG. 3B is a simplified flow chart illustrating another embodiment of the present invention; and

FIG. 3C is a simplified flow chart illustrating another embodiment of the present invention.

### DETAILED DESCRIPTION

In the following detailed description, reference is made to the accompanying drawings which form a part hereof, and in which is shown, by way of illustration, different embodiments in which the invention may be practiced. These embodiments are described in sufficient detail to enable those skilled in the art to practice the invention. Other embodiments may be utilized and structural, logical, and electrical changes may be made without departing from the scope of the present invention.

Although not required, embodiments of the invention are described in the general context of computer-executable instructions, such as program modules, being executed by a personal computer. Generally, program modules include routines, programs, objects, components, data structures, etc. that perform particular tasks or implement particular abstract data types. Those skilled in the art will appreciate that other computer system configurations, including hand-held devices, multi-processor systems, microprocessor based or programmable consumer electronics, network PCs, minicomputers, mainframe computers, and the like can be used to practice embodiments of the invention.

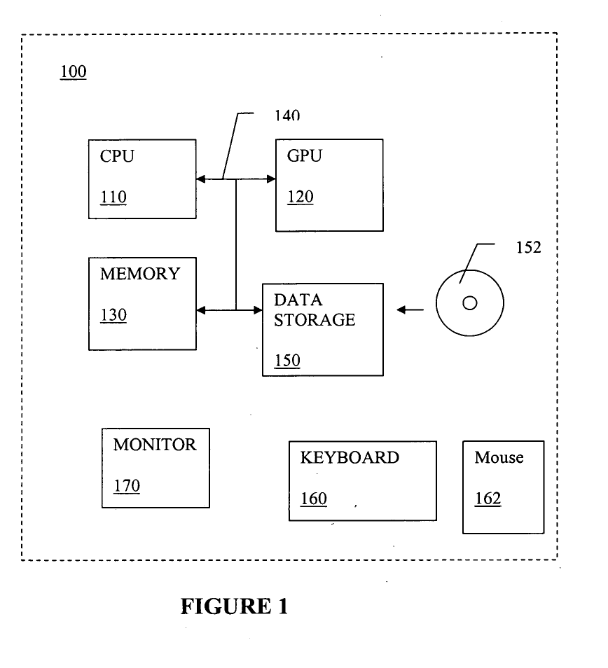

An example system for implementing embodiments the invention is illustrated in FIG. 1. FIG. 1 shows a diagrammatic representation of a machine system in the exemplary form of a computer system 100 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 100 includes a central processing unit (CPU) 110, a graphics processing unit (GPU) 120, a main memory 130 which can include a static memory, which communicate with each other via a bus 140. The computer system may further include a video display unit 170 (e.g., a liquid crystal display (LCD) or a cathode ray tube (CRT)). The computer system can also include an alphanumeric input device 160 (e.g., a keyboard), a user interface (UI) navigation device 162 (e.g., a mouse), a disk drive unit 150.

The disk drive unit 150 includes a machine-readable medium 152 on which is stored one or more sets of instructions and data structures (e.g., software) embodying or utilized by any one or more of the methodologies or functions described herein. The software may also reside, completely or at least partially, within the main memory 130 and/or within the processor(s) 110/120 during execution thereof by the computer system 100, the main memory 130 and the processor(s) 110/120 also constituting machine-readable media.

The software may further be transmitted or received over a network via a network interface device utilizing any one of a number of well-known transfer protocols (e.g., HTTP).

While the machine-readable medium 152 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Color management using the International Color Consortium (“ICC”) standard is widely implemented for converting one color space to another color space. For example, a color output from one device or software to another device or software needs to be converted (or translated) to maintain a consistent color output. Often software executed on a computer, such as image processing software, includes a color engine to determine the proper steps needed to convert one ICC color profile to another ICC color profile. The mathematical computations that are required to execute the conversion steps have traditionally been performed exclusively by the system CPU 110. The processing power of the CPU, however, may not be sufficient to provide a desired performance for color conversions. For example, depending on available playback time for conversion, a high-definition (HD) video at a 1920×1080 resolution with 24 frames per second (fps) may require 150 million pixel conversions a second. Currently available CPU's cannot perform these required computations.

As detailed herein, embodiments of the present invention shift some or all of the processing required for ICC color conversions from the CPU 110 to the GPU 120. As known to those skilled in the art, a CPU and a GPU are designed to perform different functions. A GPU may be designed as a rendering processor which executes calculations, such as matrix conversions and texture mapping, on two-dimensional or three-dimensional picture data.

Generally, texture mapping is a technique for adding a surface texture pattern to a surface of a polygon forming an object. The texture pattern is a two-dimensional image independently prepared as a texture source image. Texture mapping can be performed using look-up tables (LUT).

Embodiments of the invention use the GPU 120 for executing the processing requirements of ICC color conversion. Because the GPU 120 is not designed to perform the conversion calculations, embodiments dissect a desired color conversion into one or more steps, including texture look-up and matrix conversions.

For example, ICC color conversions are dissected into steps including a 1-Dimensional (1D), 3D, 4D or ND (N>4) sampled look-up table with interpolation, a 3×3 matrix multiplication and/or a formula-based conversion (e.g. Gamma operation Y=X).

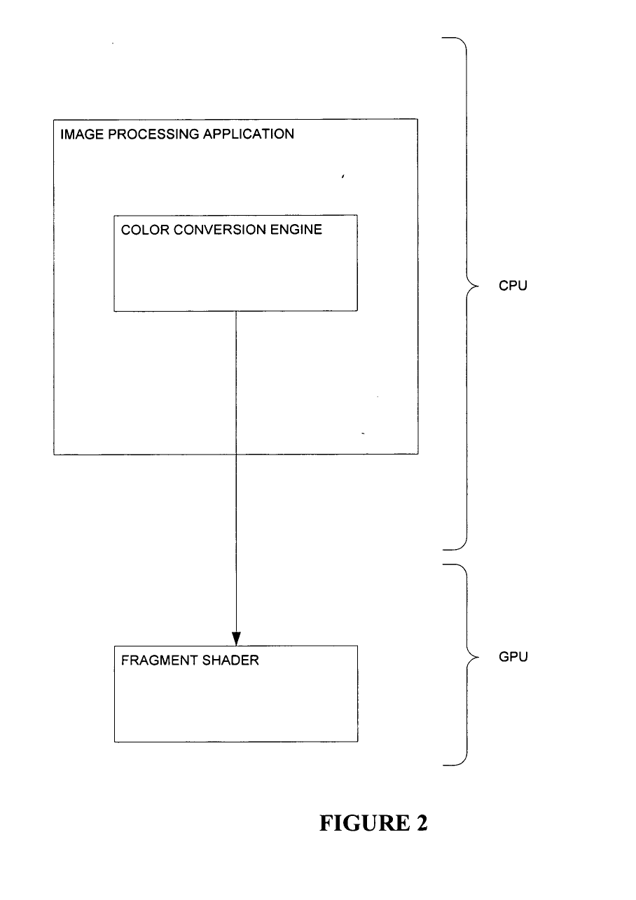

FIG. 2 illustrates an image processing application 200 that can be executed on CPU 110. For purposes of the invention the image processing application is not limited to any specific image processing function. A color conversion engine 210 is provided as a component, module or routine of the image processing application. A fragment shader 220, as explained below, is provided as a component, module or routine executed by the GPU 120.

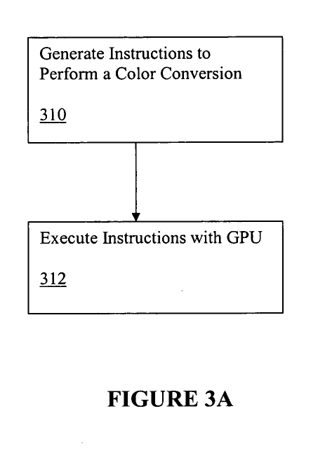

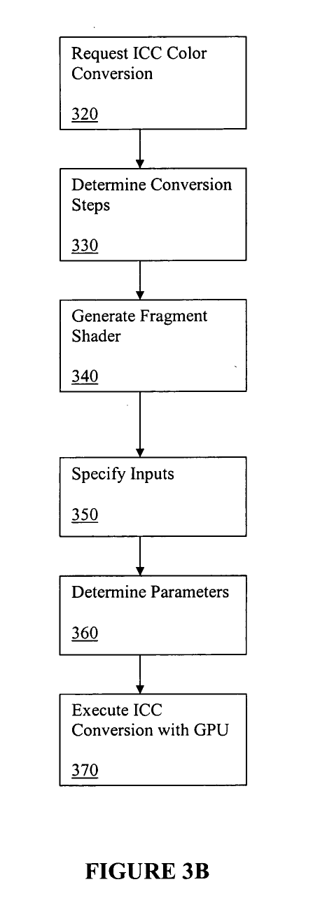

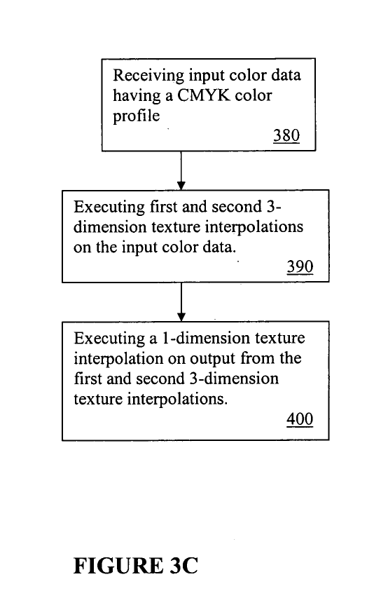

In one embodiment, illustrated in the flow chart of FIG. 3A a method 300 includes, at 310, generating instructions to perform a color conversion on input color data having a first color profile to output color data having a second color profile, At 312, the instructions are executed with a graphics processing unit (GPU).

In one embodiment, illustrated in the flow chart of FIG. 3B, a color engine executed on the computer system 100 receives a request 320 for an ICC color conversion from a requestor program. At operation 330, the color engine determines the appropriate conversion from a first ICC profile to a second ICC profile and generates a Fragment Shader program at operation 340. The Fragment Shader program is provided by the color engine to the requestor program and can be executed by the GPU 120. The Fragment Shader, in one embodiment, is a program string or sub-routine that can be combined with other program strings. As such, the processing power of the GPU can be more efficiently utilized by the requestor program. It will be understood that the generated Fragment Shader program can also be executed by the GPU independently of other operations and programs.

At operation 350, the color engine generates the Fragment Shader in real-time, or “on the fly”, and specifies input parameters for the Fragment Shader that are needed for the ICC color conversion. For example, the color engine represents a 1D sampled look-up table as a 1D textured parameter. The color engine represents 3D, 4D and ND sampled look-up tables as 3D texture parameters, and represents matrices as Matrix parameters.

In addition to specifying the Fragment Shader inputs, the color engine determines additional parameters, at operation 360, to be used by the GPU to perform the ICC color conversion while executing the Fragment Shader program. These additional parameters can include for example numerical offsets used in 1D and 3D textures for interpolation.

The Fragment Shader programs can be written in any suitable language for execution 370 by the GPU, these languages include but are not limited to OpenGL shading language, Cg language by NVLDIA® Corporation, and high-level shader language (HLSL) from Microsoft® Corporation.

The following examples are provided to help illustrate embodiments of the invention and are not intended to be limiting. The example Fragment Shader software codes are written in OpenGL language.

Different color spaces are referenced in the below examples. These color spaces are well known in the art and are not defined in detailed herein. In general, there are a plethora of other RGB color spaces. In addition to the RGB color spaces, many CMYK (Cyan Magenta Yellow Black) color spaces are well known.

### Example I

The first example is a Fragment Shader for color conversion when both source and destination ICC profiles are RGB TRC/Matrix (Tone Reproduction Curves and Matrix) profiles. These include, but are not limited to sRGB (standard RGB), and Adobe RGB.

The conversion can be executed as three input 1D look-up tables (LUT), one each for the red, green and blue color channels. One for each color red, green and blue. This is followed by a 3×3 matrix conversion. Following the matrix conversion three output 1D look-up tables are executed.

This example code can be:

uniform sampler1D OptMatrixRGBtoRGB1InCurves;
uniform mat3 OptMatrixRGBtoRGB1Matrix;
uniform sampler1D OptMatrixRGBtoRGB1OutCurves;
void OptMatrixRGBtoRGB1 (inout vec4 color);
{
color = (0.5 + 255.0 * color) / 256.0;
color.r = texture1D (OptMatrixRGBtoRGB1InCurves, color.r).r;
color.g = texture1D (OptMatrixRGBtoRGB1InCurves, color.g).g;
color.b = texture1D (OptMatrixRGBtoRGB1InCurves, color.b).b;
color.rgb = mul (OptMatrixRGBtoRGB1Matrix, color.rgb);
color = (0.5 + 2047.0 * color) / 2048.0;
color.r = texture1D (OptMatrixRGBtoRGB1OutCurves, color.r).r;
color.g = texture1D (OptMatrixRGBtoRGB1OutCurves, color.g).g;
color.b = texture1D (OptMatrixRGBtoRGB1OutCurves, color.b).b;
}

In the above example Fragmented Shader, the 1D LUT's are represented as 1D textures “sampler1D” and the 3×3 matrix is represented as “mat3.” The first line “color=(0.5+255.0*color)/256.0” is provided to scale an input color in the range [0,1] to an input LUT is represented as a 256-point 1D texture. As such, an input 0 is scaled to 0.5/256 in texture coordinates and an input 1 is scaled to 255.5/256 in texture coordinates. This is performed because the GPU considers a texture pixel to be 1×1, and the exact value of the pixel is obtained at the center of the pixel. With a 256-point 1D texture in this embodiment, the input 0 is scaled to the center of the first point and the input 1 is scaled to the center of the last point. Similarly, before the 1D interpolation of the Output 1D LUT's a “color=(0.5+2047.0*color)/2048.0” scale operation is performed where the Output 1D LUT's are 2048 entries.

### Example II

The second example is a Fragment Shader for color conversion when both source and destination ICC profiles are RGB, and at least one is a 3D-LUT based profile. These include, but are not limited to, profiles such as e-sRGB.

The conversion can be executed as three input 1D look-up tables (LUT), one each for the red, green and blue color channels. This is followed by a 3D look-up tables operation.

This example code can be:

uniform sampler1D OptRGBtoRGB3Curves;
uniform sampler3D OptRGBtoRGB3Table;
void OptRGBtoRGB3 (inout vec4 color);
{
color = (0.5 + 255.0 * color) / 256.0;
color.r = texture1D (OptRGBtoRGB3Curves, color.r).r;
color.g = texture1D (OptRGBtoRGB3Curves, color.g).g;
color.b = texture1D (OptRGBtoRGB3Curves, color.b).b;
color = (0.5 + 15 * color) / 16.0;
color.rgb = texture3D (OptRGBtoRGB3Table, color.rgb);
}

In the above example, because the 3D LUT is represented by a 16×16×16 texture, the “color=(0.5+15*color)/16.0” scaling operation is performed prior to the 3D LUT operation.

### Example III

The third example is a Fragment Shader for color conversion when the source profile is CMYK and the destination profile is RGB. The conversion can be executed as a 4D LUT, however, current GPU's do not support 4D textures. In the following example, therefore, the 4D LUT is represented by two 3D texture interpolations followed by a 1D texture interpolation.

A CMYK to RGB conversion requires a 4D LUT, for example a 9×9×9×9 LUT. Because many GPU's restrict texture dimension to be a power-of-two, the 9×9×9×9 4D LUT is represented as a 16×16×128 3D texture. The actual LUT is contained in the lower 9×9×81 portion of the texture.

This example code can be:

uniform sampler3D OptCMYKtoRGB5Table;
void OptCMYKtoRGB5 (inout vec4 color);
{
color = 1.0 − color;
float val = color.a + 8.0;
float idx = floor (val);
float frc = val − idx;
float r = (0.5 + 8.0 * color.r) / 16.0;
float g = (0.5 + 8.0 * color.g) / 16.0;
float b0 = (0.5 + 8.0 * color.b + 9.0 * idx) / 128.0;
float b1 = b0 + 9.0 / 128.0;
vec3 k0 = vec3 (r, g, b0);
vec3 k1 = vec3 (r, g, b1);
k0 = texture3D (OptCMYKtoRGB5Table, k0).rgb;
k1 = texture3D (OptCMYKtoRGB5Table, k1).rgb;
color = vec4 (mix (k0, k1, frc), 1.0);
}

In the above Example III the function vec4 is used to hold CMYK values in place of its normal RGBA (red green blue alpha) values. The 4D interpolation is performed using two 3D interpolations in the CMY cube and a 1D interpolation in the K direction.

In all three examples the 1D and 3D texture operations were performed using linear interpolation and not nearest neighbor interpolation. Further, the textures do not wrap-around, but are clamped at the edges. As such, the OpenGL options Minification Filter is set to GL_LINEAR, Magnification Filter is set to GL_LINEAR, and Wrap(S/T/R) is set to GL_CLAMP_TO_EDGE.

Embodiments described herein use a GPU to perform color conversions using ICC profiles. In some embodiments, a color engine generates Fragment Shader code executable by the GPU. The code maps ICC color conversions to GPU elements. Specifically, the ICC color conversion is represented as a series of steps mapped to particular GPU processes such as 1D texture, 3D texture and matrix functions.

In some embodiments, the color values have been scaled to texture dimensions for execution by the GPU. Further, to color convert CMYK to RGB using the GPU, two 3D interpolation steps are performed and followed by a 1D interpolation.

Referring to FIG. 3C, a method embodiment of the invention includes, at 380, receiving input color data having a Cyan-Magenta-Yellow-Black (CMYK) color profile. Executing first and second 3-dimensional texture interpolations on the input color data, at 390, with a graphics processing unit (GPU). At 400 the method includes executing a 1-dimensional texture interpolation on output from the first and second 3-dimensional texture interpolations to provide output color data having a Red-Green-Blue (RGB) color profile.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A processing system comprising:
a central processing unit (CPU); and
a graphics processing unit (GPU), wherein program instructions executed by the CPU cause the CPU to provide executable instructions to the GPU, the executable instructions consisting of a single instruction set, when executed by the GPU, causing the GPU to perform a color conversion of input color data to output color data, the color conversion according to the single instruction set including instructions for:
generating a look-up table with the GPU from the input color data, the look-up table being represented as a texture processable by the GPU;
processing the look-up table as the texture with the GPU; and
determining the output color data with the GPU based on the processing of the look-up table by the GPU.

2. The processing system of claim 1, wherein:
the input color data corresponds to first color profile data and includes first Red-Green-Blue (RGB) data; and
the output color data corresponds to second color profile data and includes second RGB data.

3. The processing system of claim 1, wherein:
the input color data corresponds to first color profile data and includes Cyan-Magenta-Yellow-Black (CMYK) data; and
the output color data corresponds to second color profile data and includes Red-Green-Blue (RGB) data.

4. (canceled)

5. The processing system of claim 1, wherein:
the input color data includes Cyan-Magenta-Yellow-Black (CMYK) data;
the output color data includes Red-Green-Blue (RGB) data; and
the processing of the look-up table with the GPU includes performing two 3-dimensional texture conversions followed by a 1-dimensional texture conversion.

6. A method comprising:
generating instructions executable by a graphics processing unit (GPU), the instructions consisting of a single instruction set to perform a color conversion of input color data to output color data, the color conversion according to the single instruction set including instructions for:
generating a look-up table with the GPU from the input color data, the look-up table being represented as a texture processable by the GPU;
processing the look-up table as the texture with the GPU; and
determining the output color data with the GPU based on the processing of the look-up table by the GPU; and
executing the instructions with the GPU.

7. The method of claim 6, wherein:
the input color data corresponds to first color profile data and includes first Red-Green-Blue (RGB) data; and
the output color data corresponds to second color profile data and includes second RGB data.

8. The method of claim 6, wherein:
the input color data corresponds to first color profile data and includes Cyan-Magenta-Yellow-Black (CMYK) data; and
the output color data corresponds to second color profile data and includes Red-Green-Blue (RGB) data.

9. The method of claim 6, wherein the instructions executable by the GPU are automatically generated by information executed by a central processing unit (CPU).

10. The method of claim 6, wherein the processing of the look-up table with the GPU includes performing a texture interpolation calculation with the GPU based on the look-up table.

11. The method of claim 6, wherein the generating of the look-up table includes scaling the input color data with the GPU.

12. The method of claim 6, wherein the processing of the look-up table with the GPU includes:
generating a matrix from the look-up table; and
performing a matrix conversion of the matrix with the GPU.

13. A method comprising:
receiving instructions in the form of a single instruction set to perform a color conversion of input color data to output color data with a graphics processing unit (GPU);
receiving the input color data that corresponds to first color profile data;
executing the single set of instructions with the GPU, the color conversion according to the single instruction set including instructions for:
generating a look-up table with the GPU from the input color data, the look-up table being represented as a texture processable by the GPU;
processing the look-up table as the texture with the GPU; and
determining the output color data with the GPU based on the processing of the look-up table by the GPU, the output color data corresponding to second color profile data.

14. The method of claim 13, wherein the processing of the look-up table with the GPU includes performing a texture interpolation calculation with the GPU based on the look-up table.

15. The method of claim 13, wherein the generating of the look-up table includes scaling the input color data with the GPU.

16. A non-transitory machine-readable storage medium comprising instructions that, when executed by one or more processors of a machine, cause the machine to perform a method comprising:
generating further instructions consisting of a single instruction set that, when executed by a graphics processing unit (GPU), cause the GPU to perform a color conversion of input color data to output color data, the color conversion according to the single instruction set including instructions for:
generating a look-up table with the GPU from the input color data, the look-up table being represented as a texture processable by the GPU;
processing the look-up table as the texture with the GPU; and
determining the output color data with the GPU based on the processing of the look-up table by the GPU;
providing the further instructions to the GPU.

17. The non-transitory machine-readable storage medium of claim 16, wherein the processing of the look-up table with the GPU includes performing a texture interpolation calculation with the GPU based on the look-up table.

18. The non-transitory machine-readable storage medium of claim 16, wherein the generating of the look-up table includes scaling the input color data.

19. The non-transitory machine-readable storage medium of claim 16, wherein:
the input color data corresponds to first color profile data and includes one of Red-Green-Blue (RGB) data or Cyan-Magenta-Yellow-Black (CMYK) data; and
the output color data corresponds to second color profile data and includes Red-Green-Blue (RGB) data.

20. The non-transitory machine-readable storage medium of claim 16, wherein:
the input color data corresponds to first color profile data and includes Cyan-Magenta-Yellow-Black (CMYK) data;
the output color data corresponds to second color profile data and includes Red-Green-Blue (RGB) data; and
the processing of the look-up table with the GPU includes performing two 3-dimensional texture conversions followed by a 1-dimensional texture conversion.
